(19) United States
(12) Patent Application Publication
(10) Pub. No.: US 2026/0161476 A1
(43) Pub. Date: Jun. 11, 2026

(54) Hardware Agnostic Selection And Allocation Of Heterogenous Compute Instances

(71) Applicant: Oracle International Corporation, Redwood Shores, CA (US)

(72) Inventor: Todd Purgason Lamb, Alpharetta, GA (US)

(73) Assignee: Oracle International Corporation, Redwood Shores, CA (US)

(21) Appl. No.: 18/976,778

(22) Filed: Dec. 11, 2024

(51) Int. Cl. G06F 9/50; G06F 11/34

(52) U.S. Cl. CPC G06F 9/5055; G06F 9/5077; G06F 11/3428

(57) ABSTRACT

Techniques for provisioning a compute instance are disclosed. A system receives a request to provision a compute instance defined at least by a set of requirements independent of particular hardware specifications. The set of requirements includes at least one of the following: a number of virtual cores, an amount of virtual memory, and a virtual input/output (I/O) capacity. The system obtains a set of heterogeneous candidate compute instance templates, respectively corresponding to different particular hardware specifications. The system filters the set of candidate compute instance templates based on the set of one or more requirements to obtain a filtered list that includes at least two heterogeneous candidate compute instance templates and provisions the compute instance based on a compute instance template selected from the filtered list.

### TECHNICAL FIELD

The present disclosure relates to cloud computing. In particular, the present disclosure relates to provisioning resources in a cloud computing environment.

### BACKGROUND

Cloud computing is a set of technologies for providing access to computing resources (e.g., processing, memory, storage, etc.) over a network such as the Internet. Some forms of cloud computing provide access to computing resources via virtual machines. A cloud service provider may provision computing resources in groups or clusters of virtual machines. In some approaches, a cloud service provider uses the same predefined configuration or template to provision resources for all customers. However, using a single configuration for all customers does not take into account each customer's specific needs; the single configuration may be wasteful for a customer with relatively low computing needs and insufficient for a customer with relatively high computing needs. In addition, using a single configuration may not be well-suited to cloud computing environments with multiple data centers with different underlying infrastructure (e.g., different numbers and/or types of processors, memory configurations, available network bandwidth, etc.). A configuration that is well-suited to one data center's underlying infrastructure may be poorly suited or even incompatible with another data center's underlying infrastructure.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. One should note that references to “an” or “one” embodiment in this disclosure are not necessarily to the same embodiment, and they mean at least one. In the drawings:

FIG. 1 is a block diagram illustrating one pattern for implementing a cloud infrastructure as a service system in accordance with one or more embodiments;

FIG. 2 is a block diagram illustrating another pattern for implementing a cloud infrastructure as a service system in accordance with one or more embodiments;

FIG. 3 is a block diagram illustrating another pattern for implementing a cloud infrastructure as a service system in accordance with one or more embodiments;

FIG. 4 is a block diagram illustrating another pattern for implementing a cloud infrastructure as a service system in accordance with one or more embodiments;

FIG. 5 is a block diagram illustrating an example computer system in accordance with one or more embodiments;

FIG. 6 illustrates a system in accordance with one or more embodiments;

FIG. 7 illustrates an example set of operations for filtering candidate compute instance templates and selecting a compute instance in accordance with one or more embodiments;

FIG. 8 illustrates an example set of operations for benchmarking compute instances and using the benchmarking information when filtering candidate compute instance templates in accordance with one or more embodiments;

FIG. 9 illustrates an example set of operations for monitoring compute instances in use and terminating non-compliant instances in accordance with one or more embodiments;

FIG. 10 illustrates an example of a cluster of heterogenous compute instances in accordance with one or more embodiments;

FIG. 11 illustrates an example of a machine learning engine in accordance with one or more embodiments; and

FIG. 12 illustrates an example set of operations for a machine learning engine in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. INFRASTRUCTURE AS A SERVICE
3. COMPUTE INSTANCE SELECTION SYSTEM ARCHITECTURE
4. FILTERING CANDIDATE COMPUTE INSTANCE TEMPLATES
5. EXAMPLE EMBODIMENT
6. MACHINE LEARNING ARCHITECTURE
7. PRACTICAL APPLICATIONS, ADVANTAGES, AND IMPROVEMENTS
8. COMPUTER NETWORKS AND CLOUD NETWORKS
9. MISCELLANEOUS; EXTENSIONS

### 1. General Overview

One or more embodiments generate a list of candidate compute instance templates that can be used to create a compute instance in response to a request for a compute instance that does not specify particular hardware requirements. The system filters an initial list of candidate compute instance templates according to hardware agnostic requirements, such as a number of virtual cores, an amount of virtual memory, and/or a virtual input/output capacity. The compute instance templates in the filtered list correspond to respective hardware specifications that may differ from one another. When multiple compute instance are requested, the system may select heterogeneous compute instance templates that have similar performance metrics to one another despite differences in underlying hardware architectures.

One or more embodiments receive a request to provision a compute instance defined at least by a set of requirements independent of particular hardware specifications. The set of requirements includes at least one of the following: a number of virtual cores, an amount of virtual memory, and a virtual input/output (I/O) capacity. The system obtains a set of heterogeneous candidate compute instance templates, respectively corresponding to different particular hardware specifications. The system filters the set of candidate compute instance templates, based on the set of one or more requirements, to obtain a filtered list including one or more heterogeneous candidate compute instance templates and provisions the compute instance based on a first selected compute instance template from the filtered list. The selection of a compute instance template may be based on a current capacity, a performance/cost relationship, or a combination thereof.

One or more embodiments described in this Specification and/or recited in the claims may not be included in this General Overview section.

### 2. Infrastructure as a Service

Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming a provider of infrastructure services.

In some examples, IaaS deployment is the process of putting a new application, or a new version of an application, onto a prepared application server or the like. IaaS deployment may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on other resources, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure that the code will be deployed on must first be set up. In some instances, the provisioning can be done manually, a provisioning tool may be utilized to provision the resources, and/or deployment tools may be utilized to deploy the code once the infrastructure is provisioned.

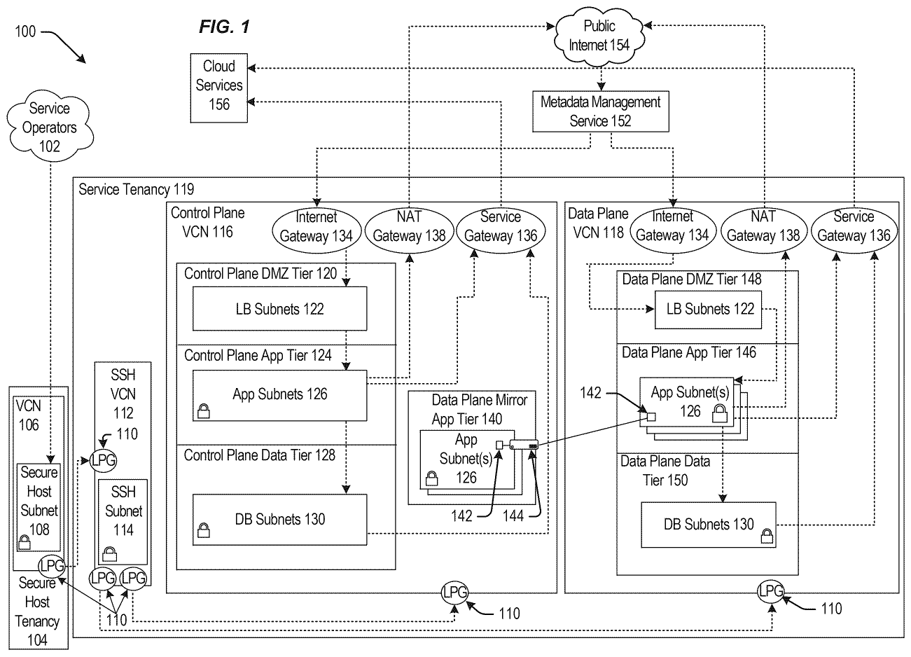

FIG. 1 is a block diagram 100 illustrating an example pattern of an IaaS architecture, according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices that may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119 that may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, that may both be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 that may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119 that may be isolated from public Internet 154.

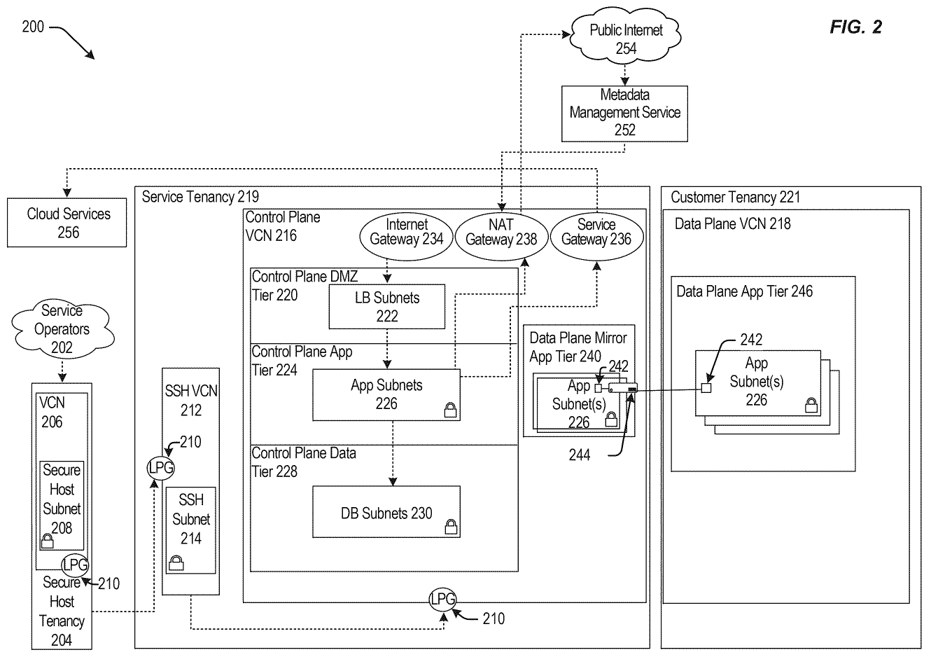

FIG. 2 is a block diagram 200 illustrating another example pattern of an IaaS architecture, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

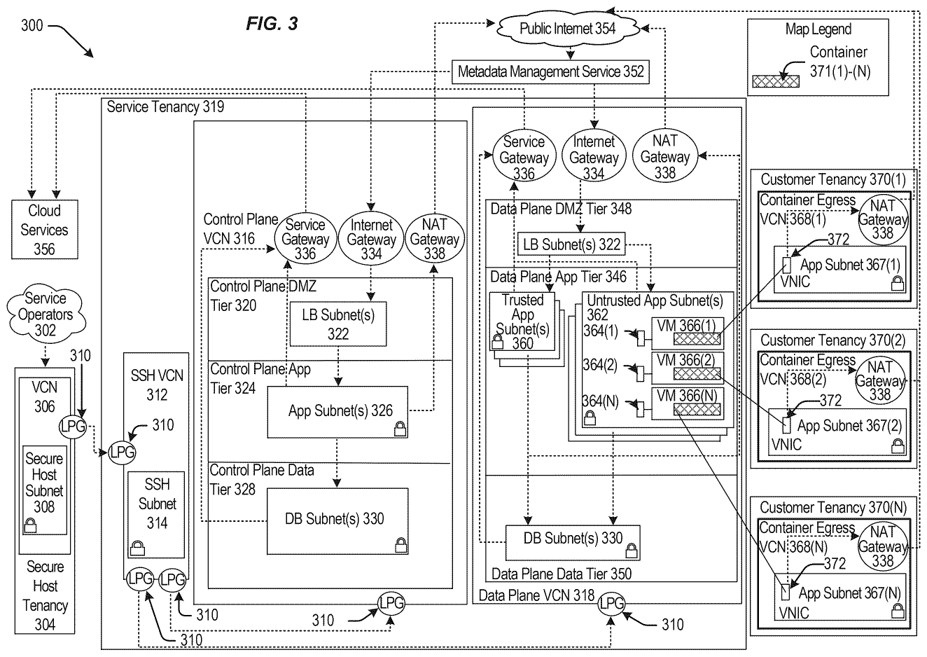

FIG. 3 is a block diagram 300 illustrating another example pattern of an IaaS architecture, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 370(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management system 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 370. Respective containers 371(1)-(N) contained in the VMs 366(1)-(N) may be configured to run the code. In this case, there can be a dual isolation (e.g., the containers 371(1)-(N) running code, where the containers 371(1)-(N) may be contained in at least the VM 366(1)-(N) that are contained in the untrusted app subnet(s) 362). The dual isolation may help prevent incorrect or otherwise undesirable code from damaging the network of the IaaS provider or from damaging a network of a different customer. The containers 371(1)-(N) may be communicatively coupled to the customer tenancy 370 and may be configured to transmit or receive data from the customer tenancy 370. The containers 371(1)-(N) may not be configured to transmit or receive data from any other entity in the data plane VCN 318. Upon completion of running the code, the IaaS provider may kill or otherwise dispose of the containers 371(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 371(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

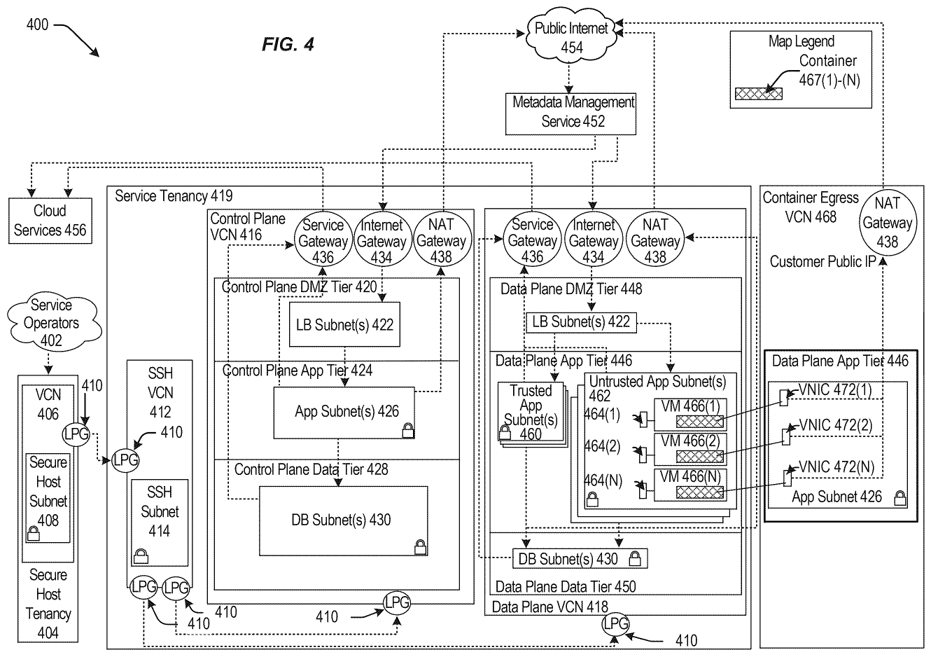

FIG. 4 is a block diagram 400 illustrating another example pattern of an IaaS architecture, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management system 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

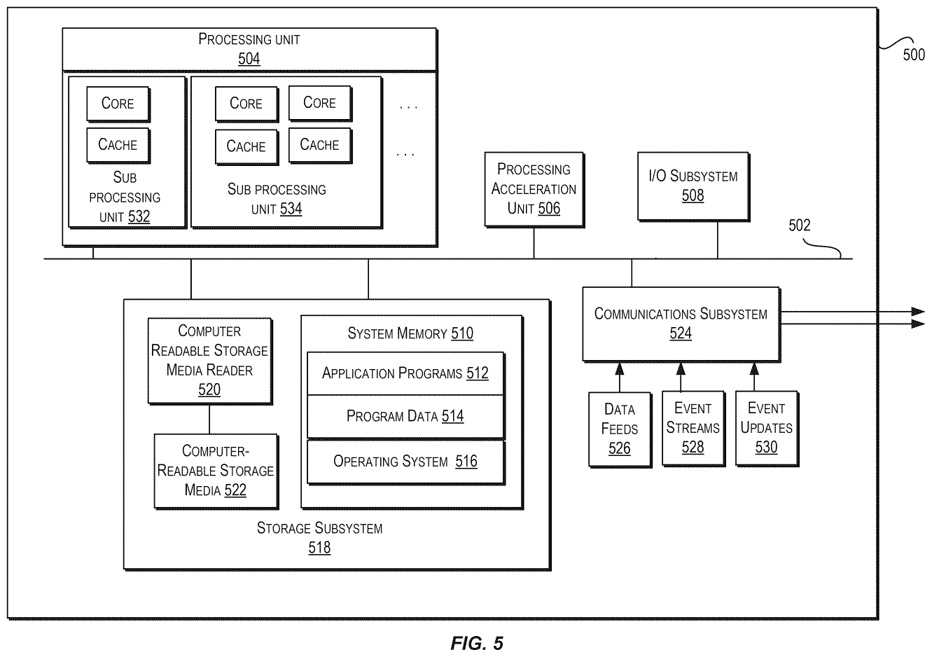

FIG. 5 illustrates an example computer system 500 that various embodiments may be implemented in. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus that can be implemented as a Mezzanine bus manufactured to the IEEE P1386.1 standard.

Processing unit 504 that can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions that are loadable and executable by processing unit 504. System memory 510 may also store data that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500, such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams that may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in the figure is intended as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 3. Compute Instance Configuration System Architecture

A compute instance template, also known as a compute shape, describes a set of processing resources that can be allocated to a user as a compute instance within a cloud service provider's environment for performing some function or set of functions. A compute instance template may specify number of resources, such as a number of cores or an amount of memory without specifying particular versions or models of the hardware resources.

A compute instance is a specific set of hardware resources provisioned according to a compute instance template and defined by a processing unit of a particular processor type, a number of cores for the processing unit, and an amount of memory available for use by the processing unit. A processor type may be defined by a processor architecture, e.g., x86 or ARM; a processor vendor, e.g., Intel, Advanced Micro Devices (AMD), or ARM; and a generation.

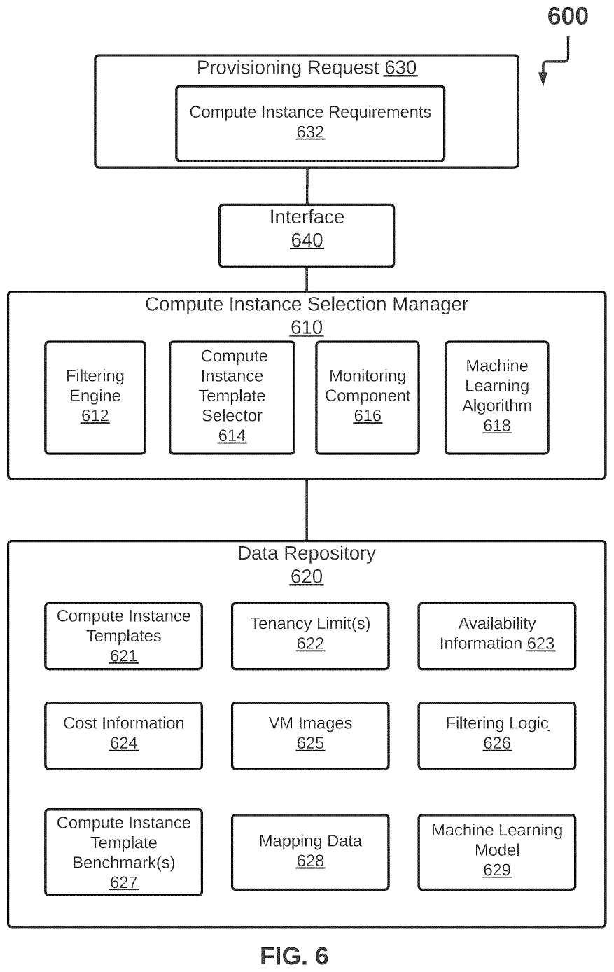

FIG. 6 illustrates a system 600 in accordance with one or more embodiments. As illustrated in FIG. 6, system 600 includes a compute instance selection manager 610, a data repository 620, and an interface 640. The compute instance configuration selection manager 610 may include one or more functional components, such as a filtering engine 612, a compute instance template selector 614, a monitoring component 616, and a machine learning algorithm 618.

In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

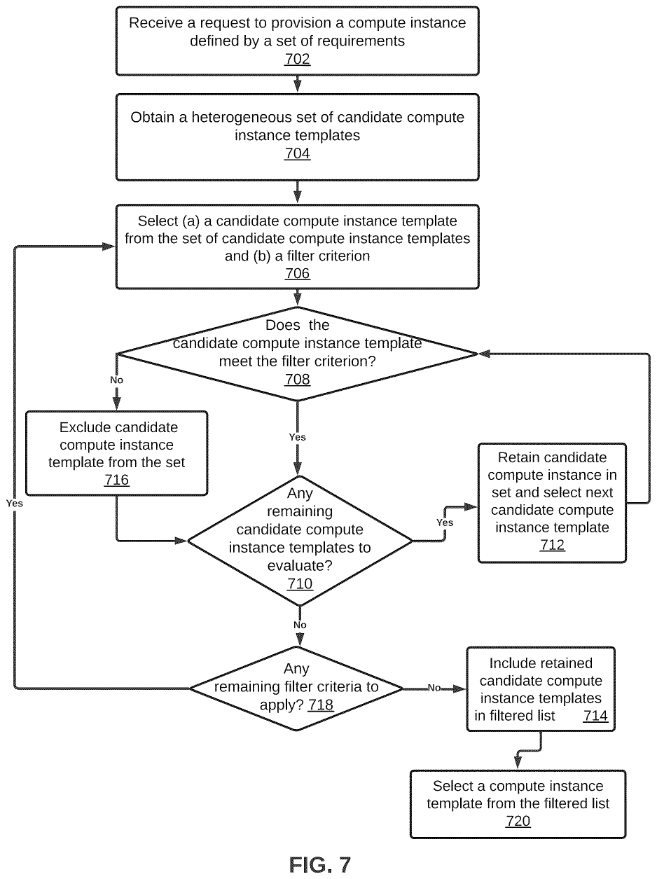

In one or more embodiments, the compute instance selection manager 610 refers to hardware and/or software configured to perform operations described herein for receiving a provisioning request 630 from a user to create a compute instance, where the request does not require specific hardware components. The compute instance selection manager 610 is configured to filter a set of candidate compute instance templates and select a candidate compute instance to provision and launch. Examples of operations for receiving the request to create a compute instance, filtering a set of candidate compute instance templates, and selecting a candidate compute instance are described below with reference to FIGS. 7-9.

In one or more embodiments, the filtering engine 612 refers to hardware and/or software configured to perform operations described herein for filtering a set of candidate compute instance templates 612 according to a set of compute instance requirements 632 in the provisioning request 630 to produce a filtered list of candidate compute instance templates capable of meeting the set of compute instance requirements 632.

In one or more embodiments, the set of compute instance requirements 632 may specify one or more of a number of virtual cores, an amount of virtual memory, and a virtual input/output (I/O) capacity. A virtual core is an abstraction of a hardware processing unit that has defined performance metrics but does not specify a particular model or manufacturer of a physical processing unit. Virtual memory is an abstraction of memory hardware having defined performance metrics without requiring a particular model or manufacturer. A virtual I/O capacity is an abstraction of I/O hardware having defined performance metrics without requiring a particular model or manufacturer. The abstraction could manifest to other virtual resources, to physical resources, or to a combination of virtual and physical resources. Virtual cores, virtual memory, and virtual I/O is distinct from a hardware virtualization such as may be carried out in a hypervisor or an operating system.

The filtering engine 612 may filter the set of candidate compute instance templates 612 such that the compute instance templates on the filtered list can support the requested number of virtual cores, amount of virtual memory, and virtual I/O capacity. In addition to considering the set of compute instance requirements 632, the filtering engine 612 may filter the candidate compute instance templates according to filtering criteria, such as tenancy limits 622, availability information 623, and cost information 624.

Tenancy limits 622 may include information about the individual tenancies served by the cloud computing service. The information may specify the types and/or amounts of compute resources that a tenancy may use as well as how much of the allowed resources are in use or available for use by the tenancy. Availability information 623 may include information about what compute instance resources are in use and therefore not available, and what compute instance resources are not in use and therefore available for allocation to a user. Cost information 624 may include information about the cost of obtaining a compute instance resource, the cost of operating a compute instance template resource, and/or a profit associated with operating a compute instance resource.

In one or more embodiments, the filtering engine 612 may use filtering logic 626. Filtering logic 626 may include, for example, a set of one or more filters, an ordered set of filters, and/or one or more decision trees for including or excluding a candidate compute instance template from the filtered list.

In one or more embodiments, the compute instance template selector 614 refers to hardware and/or software configured to perform operations described herein for selecting a compute instance template from the filtered list for provisioning as a compute instance. When the filtered list includes more than one compute instance template, the compute instance template selector 614 may select the compute instance template at the top of the list. Alternatively, the compute instance template selector 614 may select a compute instance template according to one or more criteria, for example, a compute instance template associated with the lowest cost of operation or the compute instance template associated with a set of resources that have more availability. In one or more embodiments, the machine learning algorithm 618 may apply a machine learning model 629 to the compute instance templates in the filtered list to weight or rank the compute instance templates such that the compute instance template selection 614 can select the compute instance template with the largest weight or highest rank.

In one or more embodiments, the monitoring component 616 refers to hardware and/or software configured to perform operations described herein for monitoring the state of a virtual machine in use for compliance with the compute instance template configuration used to provision the compute resources used by the virtual machine. When the state of the virtual machine does not comply with the compute instance template configuration, the monitoring component 616 may mark the virtual machine for termination. The monitoring component 616 may terminate the virtual machine or may instruct another functional component to terminate the virtual machine. Additionally, the monitoring component 616 may initiate the replacement of the terminated virtual machine via the compute instance selection manager 610.

In one or more embodiments, the compute instance selection manager 610 is configured to create and launch a particular compute instance based on a selected compute instance template. For example, the compute instance selection manager 610 may allocate, to a requesting user, a number of cores for a specific processing unit of a processor type within a particular region and/or availability domain. The compute instance selection manager 610 may then make the allocated cores available to the requesting user along with any additional resources, such as network and storage resources, that the user may need to make use of the compute instance. Alternatively, the compute instance selection manager 610 may provide the selected compute instance template to another system or functional component to create and launch the particular compute instance.

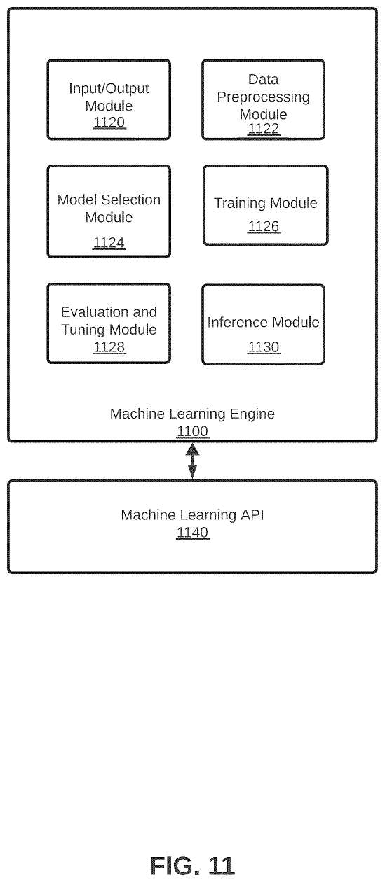

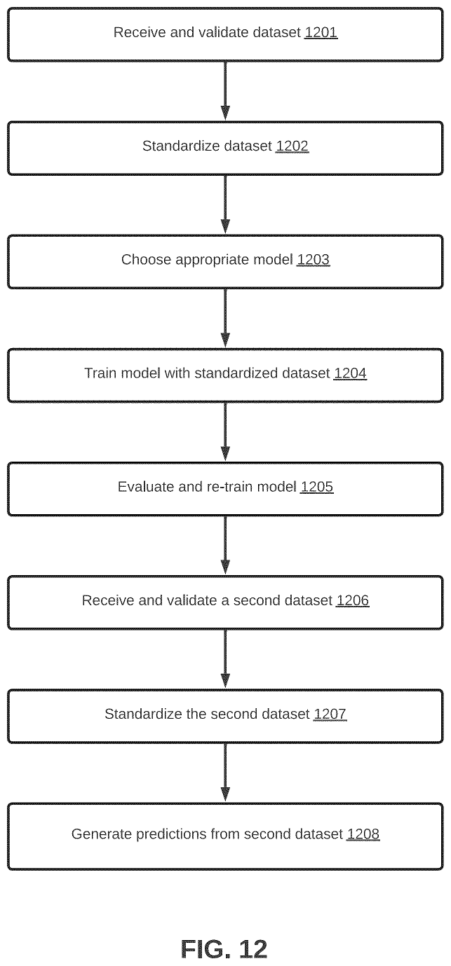

In one or more embodiments, a machine learning algorithm 618 is an algorithm that can be iterated to learn a target model/that best maps a set of input variables to an output variable. In particular, a machine learning algorithm 618 is configured to generate and/or train a machine learning model 629. Examples of machine learning architecture and processes are described further below with respect to FIGS. 11 and 12.

In one or more embodiments, a data repository 620 is any type of storage unit and/or device (e.g., a file system, database, collection of tables, or any other storage mechanism) for storing data. Furthermore, a data repository 620 may include multiple different storage units and/or devices. The multiple different storage units and/or devices may or may not be of the same type or located at the same physical site. Furthermore, a data repository 620 may be implemented or executed on the same computing system as the compute instance selection manager 610. Additionally, or alternatively, a data repository 620 may be implemented or executed on a computing system separate from the compute instance selection manager 610. The data repository 620 may be communicatively coupled to the compute instance selection manager 610 via a direct connection or via a network.

The data repository 620 may include compute instance templates 621. The compute instance templates 621 may include one or more types of compute instance templates that the cloud service provider offers to users along with information needed to launch a compute instance from a compute instance template.

A virtual machine (VM) image 625 may include a file or a collection of files that includes the complete and bootable environment for a VM. The image may include an operating system (OS), software, configurations, and other data that allow the VM to function as a standalone, fully operational computer. In some embodiments, a VM image may be associated with a list of compute instance templates that may be suitable for use with a particular VM image.

Compute instance template benchmark information 627 may include a stored result of a benchmark test performed on a set of physical or virtual resources defined by a hardware specification associated with a compute instance template.

Mapping data 628 may include a stored association between a compute instance template and a set of performance requirements where the association is based on a benchmark result for the compute instance template. One set of performance metrics may be mapped to more than one compute instance template even when the compute resources associated with the respective compute instance templates differ from each other.

Information describing the compute instance selection manager 610 may be implemented across any of components within the system 600. However, this information is illustrated within the data repository 620 for purposes of clarity and explanation.

In an embodiment, the compute instance configuration selection manager 610 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 640 refers to hardware and/or software configured to facilitate communications between a user and the compute instance configuration selection manager 610. Interface 640 renders user interface elements and receives input via user interface elements. Examples of interfaces include a graphical user interface (GUI), a command line interface (CLI), a haptic interface, an application programming interface (API) accessed via a console, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 640 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 640 is specified in one or more other languages, such as Java, C, or C++.

Additional embodiments and/or examples relating to computer networks are described below in Section 8, titled “Computer Networks and Cloud Networks.”

### 4. Filtering Candidate Compute Instance Templates

FIG. 7 illustrates an example set of operations for filtering candidate compute instance templates and selecting a compute instance in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In one or more embodiments, the system receives a request to provision a compute instance defined by a set of requirements (Operation 702). The system may receive the request via an interface. The set of requirements may include a number of nodes to create. The set of requirements may include a number of virtual cores, an amount of virtual memory, and/or an input/output (I/O) capacity to use. The set of requirements may include additional requirements, such as a version of software that will execute on the compute instance, a particular availability domain, and/or features of the software to enable or disable. The set of requirements can be hardware agnostic. That is, the requirements do not need to include specific hardware requirements such as a particular type and version of processor.

In one or more embodiments, the system maps a number of nodes specified in the request to a number of virtual cores and calculates an amount of virtual memory based on the number of virtual cores. One node may correspond to one virtual core. One virtual core may be mapped to a minimum amount of virtual memory.

In one or more embodiments, the system obtains a heterogenous set of candidate compute instance templates (Operation 704). The system may begin with a complete set of compute instance templates stored in the system. Alternatively, the system may obtain a set of candidate compute instance templates by selecting a subset of the complete set, for example, according to compute instance templates corresponding to resources that the requesting customer is permitted to use or according to what resources are available in a requested availability domain or based in part on any additional requirements included in the request. The set of candidate compute instance templates may be a grouping of template files stored in one or more storage directories. The set of candidate compute instance templates may be entries in a data structure, such as a list or a database, that includes references or links to template files stored in a directory.

In one or more embodiments, the system selects a candidate compute instance template and a filter criterion (Operation 706). The system may select the first candidate compute instance template in the set. Alternatively, the system may randomly select a candidate compute instance template. The system may select the first filter criterion from an ordered list of filter criterion. Additionally, or alternatively, the system may initiate filtering logic that executes filtering operations in an order defined by the filtering logic.

In one or more embodiments, the system determines if the candidate compute instance template meets the filter criterion (Operation 708). The system may compare a requested number of virtual cores and virtual memory to the actual cores and actual memory specified in the candidate compute instance template. If one virtual core and 15 GB of memory is requested, a compute instance template that has one actual core and 8 GB of memory may not meet the filter criteria, while a compute instance template that has one actual core and 16 GB of memory does meet the filter criterion.

The system may evaluate a candidate compute instance template to determine if a specified version of software is capable of executing on the requested compute instance. For example, for a KUBERNETES cluster, the system may evaluate a version of KUBERNETES against the architecture of a processor included in the compute instance template.

The system may determine, when a VM image is specified, if a candidate compute instance template is included in a list of compute instance templates associated with the VM image.

The system may determine, for a compute instance template that has fixed specifications, e.g., a defined number of cores, if the fixed specification candidate compute instance template meets the requested compute instance requirements. Some compute instance templates have a range of values for the defined resources, for example, minimum and maximum values for the number of cores or for an amount of memory. The system may accordingly determine if any of the values within the range of possible values for candidate compute instance template meets the requested compute instance requirements.

The system may evaluate, for the tenancy associated with the request, what types of resources and how many resources are permitted for use. The system may determine, for a given compute instance template, an amount of CPU availability relative to a maximum value for that compute instance template and an amount of memory availability relative to a maximum value for that compute instance template. The system determines how many cores would be needed if the candidate compute instance template were used for all VMs in the tenancy. If the limits of the tenancy are not exceeded, then the candidate compute instance template meets this filter criterion.

The system may determine if the requested compute instance can operate on an efficient VM. An efficient VM is a compute instance operating on an efficient core. Efficiency may refer to cost efficiency, energy efficiency, hardware usage efficiency, or some combination of efficiencies. An example of an efficient core may include one with an ARM-based architecture or a burstable feature. The efficient VM may be more cost-effective for the cloud service operator although it may be less performant. The system may determine if a compute instance template for an efficient VM may be included in the filtered list according to the requested number of cores. The system may allow compute instance templates for efficient VMs to be included when the number of cores does not exceed a threshold, e.g., 4 or 5 cores.

In one or more embodiments, when the candidate compute instance template meets the filter criterion, the system determines if there are any remaining candidate compute instance templates to evaluate against the filter criterion (Operation 710). When there are one or more remaining candidate compute instance templates to evaluate, the system retains the currently evaluated candidate compute instance template in the set of candidate compute instance templates and selects another candidate compute instance template (Operation 712), returning to Operation 708 to evaluate the newly selected candidate compute instance template.

When the candidate compute instance template does not meet the filter criterion, the system excludes the candidate compute instance template from the set of candidate compute instance templates (Operation 716). In one or more embodiments, the system may remove the compute instance template from the set of candidate compute instance templates or may indicate that the compute instance template did not meet the filter criteria, for example, with a flag or other indicator.

When there are no remaining candidate compute instance templates to evaluate, the system determines if there are any remaining filter criteria to apply (Operation 718). When there are remaining filter criteria, the system returns to Operation 706 to select a new filter criterion and a candidate compute instance from the set.

When there are no more filter criteria to apply, the system includes the candidate compute instance template that remain in the set to a list or set that includes compute instance templates that have met the applied filter criteria. Alternatively, the system retains the compute instance templates within the set of candidate compute instance templates and may indicate that the remaining compute instance templates have met the filter criteria, for example, with a flag or other indicator.

In one or more embodiments, when there are no remaining candidate compute instance templates for evaluation, the system selects a compute instance template from the filtered list for instantiation (Operation 720). When there is one compute instance template in the filtered list, the system selects that compute instance template. If there are no compute instance templates in the filtered list, the system may issue an error. Additionally, or alternatively, the system may select the last candidate compute instance template that was excluded to use to provision a compute instance.

When there are multiple compute instance templates in the filtered list, the system may provide the filtered list to a provisioning service to select a compute instance template. In one or more embodiments, the system may weight the compute instance templates in the filtered list according to cloud computing service preferences, such as cost of operation or available resources, before providing the list to the provisioning service. The system may apply a machine learning model to the filtered list to weight the items in the filtered list. When the number of compute instance templates in the filtered list exceeds a maximum allowed number, the system may rank the compute instance templates according to cloud computing service preferences and remove the lowest ranked compute instance templates until the remaining number does not exceed the maximum allowed number. The system may apply a machine learning model to rank the compute instance templates.

The system may then launch a compute shape according to the selected compute instance template.

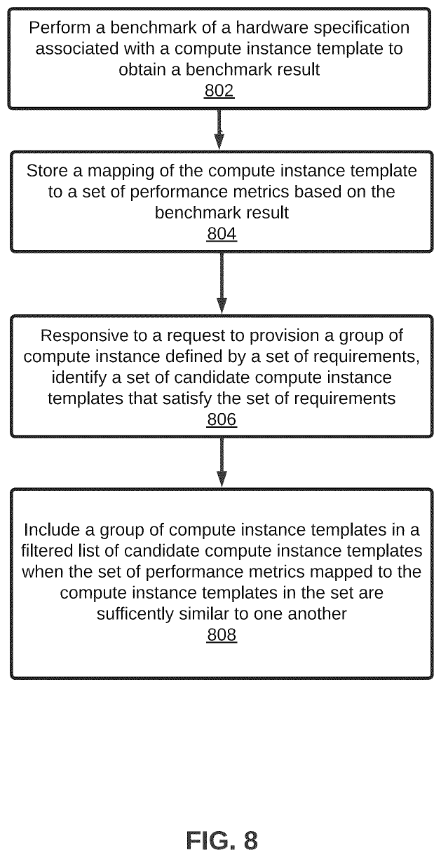

FIG. 8 illustrates an example set of operations for benchmarking compute instances and using the benchmarking information when filtering candidate compute instance templates in accordance with one or more embodiments. One or more operations illustrated in FIG. 8 may be modified, rearranged, or omitted. Accordingly, the particular sequence of operations illustrated in FIG. 8 should not be construed as limiting the scope of one or more embodiments.

In one or more embodiments, the system performs a benchmark of a hardware specification associated with a compute instance template to obtain a benchmark results (Operation 802). For a processor, the system may measure, for example, the clock speed, instructions per clock cycle, and/or performance of specific types of tasks, such as encryption, floating-point math, or compression. For memory, the system may measure, for example, bandwidth, latency, read/write speed, and throughput. For I/O capacity, the system may measure, for example, throughput, latency, transfer rate, and a number of simultaneous I/O operations handled. The system may test application specific performance such as load testing for KUBERNETES.

In one or more embodiments, the system stores a mapping of the compute instance template to a set of performance metrics based on the benchmark result (Operation 804). The system may store a mapping between the compute instance template to the benchmark results for the associated hardware. The system may store the benchmark results in association with the compute instance template, for example, as metadata, or in a field of the template. The system may calculate the set of performance metrics from the benchmark results, for example, by using one or more benchmark results as inputs to a scoring function that produces a metric.

In one or more embodiments, the system receives a request to provision a group of compute instances defined by a set of requirements, and in response, identifies a set of compute instance templates that satisfy the set of requirements (Operation 806). The request may specify two nodes, corresponding to two virtual cores, and the system may identify a set of compute instance templates that support two virtual cores.

In one or more embodiments, the system includes a group of compute instance templates in a filtered list of candidate compute instance templates when the set of performance metrics mapped to the respective compute instance templates are sufficiently similar to one another (Operation 808). The system compares the performance metrics mapped to the respective compute instance templates and may group the compute instance templates in the set according to the similarity of the respective performance metrics. For example, the system may group compute instance templates having performance metrics within some threshold of similarity, e.g., within 5% or 10%, of each other. The system may determine a grouping that includes a sufficient number of compute instance templates to satisfy the set of requirements. The system includes the grouping in a filtered list of candidate compute instance templates. If more than one grouping includes a sufficient number of compute instance templates, the system may include multiple groups in the filtered list. The system may map or otherwise associate the compute instance templates in a group to each other such that when a provisioning service selects one compute instance template for provisioning, the other compute instance templates in the associated grouping are also provisioned.

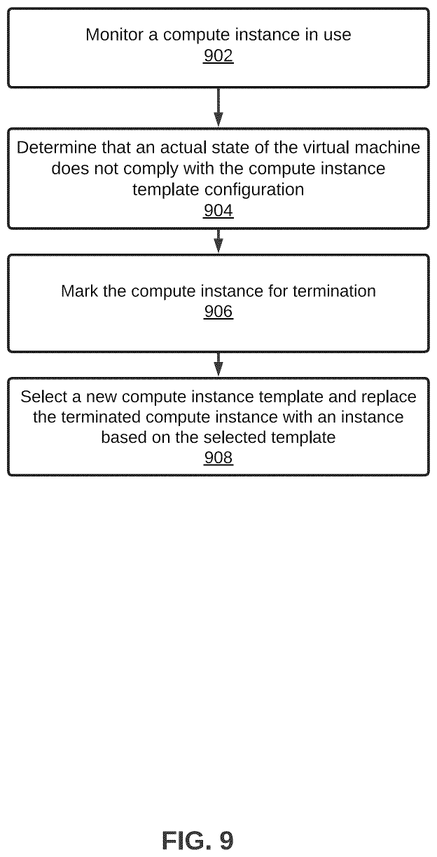

FIG. 9 illustrates an example set of operations for monitoring compute instances in use and terminating non-compliant instances in accordance with one or more examples. One or more operations illustrated in FIG. 9 may be modified, rearranged, or omitted. Accordingly, the particular sequence of operations illustrated in FIG. 9 should not be construed as limiting the scope of one or more embodiments.

In one or more embodiments, the system monitors a compute instance in use (Operation 902). The compute instance may be used by a virtual machine. A virtual machine (VM) can have a corresponding configuration definition, for example, a corresponding API object that includes what compute instance template the VM is using and how many cores the VM has. The system monitors the current compute instance configuration and an actual state of the VM. The actual state of the VM includes, for example, what compute instance template the VM is based on and how many cores the VM has.

The system may monitor changes in a list of valid configurations. The list of valid configurations may exist in the system for selection of one or more compute instances. When the list changes, for example, when a previously valid configuration is removed, a new valid configuration is added, or a valid configuration is modified, the system may compare the compute instance in use with the configurations in the list.

In one or more embodiments, the system determines that the actual state of the virtual machine using the compute instance does not comply with the compute instance template configuration (Operation 904). The system may determine that the actual state of the VM does not comply if one or more of the actual values in the compute instance configuration do not match corresponding values in the configuration definition for the VM. The system may determine that the actual state of the VM does not comply if one or more of the actual values in the compute instance configuration does not match one or more parameters of a configuration in the list of valid configurations.

In one or more embodiments, the system marks the compute instance for termination when the VM is not compliant with the configuration (Operation 906). The system may set a flag associated with the compute instance to indicate termination. The system may call or invoke a termination process and provide an identifier of the compute instance for termination.

In some cases, the system may mark a compute instance for termination when the system determines that the customer needs more nodes or needs more resources within the existing nodes. Marking a compute instance for termination then causes the system to select and provision a new compute instance that meets the additional requirements of the customer.

In some cases, the system may mark a compute instance for termination based on the compute instance template used to create the compute instance. This may allow the system to force the termination of a compute instance so that another compute instance template, e.g., a newer one, can be used instead.

In one or more embodiments, the system selects a new compute instance template and replaces the terminated compute instance with an instance based on the newly selected compute instance template (Operation 908). The system may repeat the process illustrated in FIG. 7 to select a new compute instance template. Alternatively, the system may select another compute instance template from the previously generated filtered list that was used to select and provision the terminated compute instance.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

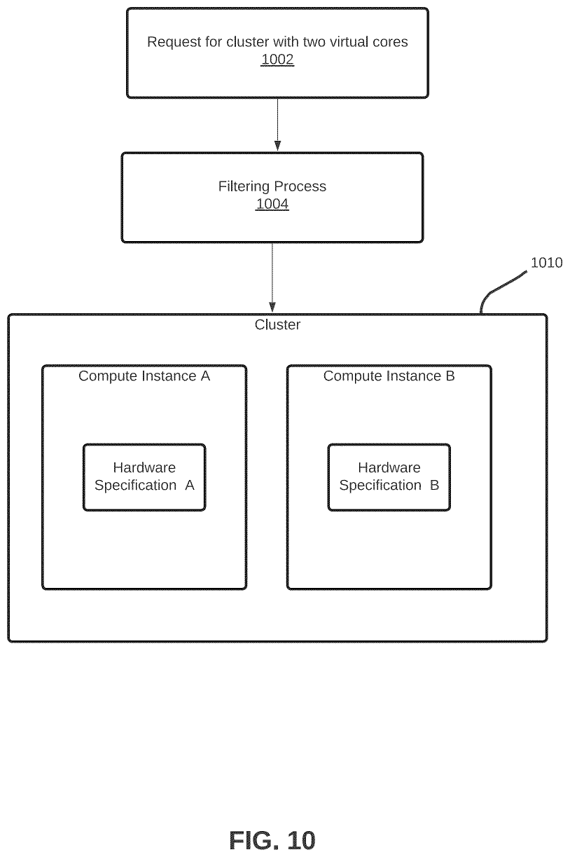

FIG. 10 illustrates an example of a cluster 1010 of heterogenous compute instances in accordance with one or more embodiments. The cluster 1010 may be a KUBERNETES cluster. Responsive to a request 1002 for a cluster with two virtual cores, the system maps the two virtual cores to two actual cores and applies the filtering process 1004.

The system selects two different compute instance templates from the filtered list, where the compute instance templates correspond to Kubernetes Manager Instances (KMI). The system selects two compute instance templates having respective benchmark information that is sufficiently similar to one other within a threshold value.

The system then provisions and launches Compute Instance A corresponding to one virtual core and Compute Instance B corresponding to the second virtual core. Compute Instance A uses compute resources defined by Hardware Specification A, and Compute Instance B uses compute resources defined by Hardware Specification B. Hardware Specification A may have different underlying architecture than Hardware Specification B. For example, Hardware Specification A may use ARM processors, while Hardware Specification B may use x86 processors. Regardless of the underlying hardware architectures, the performance of operations on one compute instance may be indistinguishable, at least to a human, from the performance of the same operations on the other compute instance.

### 6. Machine Learning Architecture

FIG. 11 illustrates a machine learning engine 1100 in accordance with one or more embodiments. As illustrated in FIG. 11, machine learning engine 1100 includes input/output module 1120, data preprocessing module 1122, model selection module 1124, training module 1126, evaluation and tuning module 1128, and inference module 1130.

In accordance with an embodiment, input/output module 1120 serves as the primary interface for data entering and exiting the system, managing the flow and integrity of data. This module may accommodate a wide range of data sources and formats to facilitate integration and communication within the machine learning architecture.

In an embodiment, an input handler within input/output module 1120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 1120 to be versatile in different operational contexts, whether processing historical datasets or streaming data.

In accordance with an embodiment, input/output module 1120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 1120 includes an output framework designed to handle the distribution and exportation of outputs, predictions, or insights. Using the output framework, input/output module 1120 formats these outputs into user-friendly and accessible formats, such as reports, visualizations, or data files compatible with other systems. Input/output module 1120 also ensures secure and efficient transmission of these outputs to end-users or other systems in an embodiment and may employ encryption and secure data transfer protocols to maintain data confidentiality.

In accordance with an embodiment, data preprocessing module 1122 transforms data into a format suitable for use by other modules in machine learning engine 1100. For example, data preprocessing module 1122 may transform raw data into a normalized or standardized format suitable for training ML models and for processing new data inputs for inference. In an embodiment, data preprocessing module 1122 acts as a bridge between the raw data sources and the analytical capabilities of machine learning engine 1100.

In an embodiment, data preprocessing module 1122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 1122 may be configured to handle anomalies in different ways depending on context. Data preprocessing module 1122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 1122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 1122 processes new data for inference, data preprocessing module 1122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 1124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 1124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 1124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 1124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 1124 also considers computational efficiency and resource constraints. This is meant to help ensure the selected model is both accurate and practical in terms of computational and time requirements. In an embodiment, certain features of model selection module 1124 are configurable such as a configured bias toward (or against) computational efficiency.

In accordance with an embodiment, training module 1126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 1126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 1126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 1126 includes logic to handle different types of data and learning tasks. For instance, it includes different training routines for supervised learning (where the training data comes with labels) and unsupervised learning (without labeled data). In the case of deep learning models, training module 1126 also manages the complexities of training neural networks that include initializing network weights, choosing activation functions, and setting up neural network layers.

In an embodiment, evaluation and tuning module 1128 incorporates dynamic feedback mechanisms and facilitates continuous model evolution to help ensure the system's relevance and accuracy as the data landscape changes. Evaluation and tuning module 1128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 1128 performs continuous model tuning by using hyperparameter optimization. Evaluation and tuning module 1128 performs an exploration of the hyperparameter space using algorithms, such as grid search, random search, or more sophisticated methods like Bayesian optimization. Evaluation and tuning module 1128 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 1128 integrates data feedback and updates the model. Evaluation and tuning module 1128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 1128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 1128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 1130 transforms data raw data into actionable, precise, and contextually relevant predictions. In addition to processing and applying a trained model to new data, inference module 1130 may also include post-processing logic that refines the raw outputs of the model into meaningful insights.

In an embodiment, inference module 1130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 1130 transforms the outputs of a trained model into definitive classifications. Inference module 1130 employs the underlying model as a tool to generate probabilistic outputs for each potential class. It then engages in an interpretative process to convert these probabilities into concrete class labels.

In an embodiment, when inference module 1130 receives the probabilistic outputs from the model, it analyzes these probabilities to determine how they are distributed across some or every potential class. If the highest probability is not significantly greater than the others, inference module 1130 may determine that there is ambiguity or interpret this as a lack of confidence displayed by the model.

In an embodiment, inference module 1130 uses thresholding techniques for applications where making a definitive decision based on the highest probability might not suffice due to the critical nature of the decision. In such cases, inference module 1130 assesses if the highest probability surpasses a certain confidence threshold that is predetermined based on the specific requirements of the application. If the probabilities do not meet this threshold, inference module 1130 may flag the result as uncertain or defer the decision to a human expert. Inference module 1130 dynamically adjusts the decision thresholds based on the sensitivity and specificity requirements of the application, subject to calibration for balancing the trade-offs between false positives and false negatives.

In accordance with an embodiment, inference module 1130 contextualizes the probability distribution against the backdrop of the specific application. This involves a comparative analysis, especially in instances where multiple classes have similar probability scores, to deduce the most plausible classification. In an embodiment, inference module 1130 may incorporate additional decision-making rules or contextual information to guide this analysis, ensuring that the classification aligns with the practical and contextual nuances of the application.

In regression models, where the outputs are continuous values, inference module 1130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 1130 incorporates domain-specific adjustments into its post-processing routine. This involves tailoring the model's output to align with specific industry knowledge or contextual information. For example, in financial forecasting, inference module 1130 may adjust predictions based on current market trends, economic indicators, or recent significant events, ensuring that the outputs are both statistically accurate and practically relevant.

In an embodiment, inference module 1130 includes logic to handle uncertainty and ambiguity in the model's predictions. In cases where inference module 1130 outputs a measure of uncertainty, such as in Bayesian inference models, inference module 1130 interprets these uncertainty measures by converting probabilistic distributions or confidence intervals into a format that can be easily understood and acted upon. This provides users with both a prediction and an insight into the confidence level of that prediction. In an embodiment, inference module 1130 includes mechanisms for involving human oversight or integrating the instance into a feedback loop for subsequent analysis and model refinement.

In an embodiment, inference module 1130 formats the final predictions for end-user consumption. Predictions are converted into visualizations, user-friendly reports, or interactive interfaces. In some systems, like recommendation engines, inference module 1130 also integrates feedback mechanisms, where user responses to the predictions are used to continually refine and improve the model, creating a dynamic, self-improving system.

In an embodiment, machine learning engine API 1140 allows for applications to leverage machine learning engine 1100. In an embodiment, machine learning engine API 1140 may be built on a RESTful architecture and offer stateless interactions over standard HTTP/HTTPS protocols. Machine learning engine API 1140 may feature a variety of endpoints, each tailored to a specific function within machine learning engine 1100. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 1140 is equipped to support SOAP-based interactions. This extension involves defining a WSDL (Web Services Description Language) document that outlines the API's operations and the structure of request and response messages. In an embodiment, machine learning engine API 1140 supports various data formats and communication styles. In an embodiment, machine learning engine API 1140 endpoints may handle requests in JSON format or any other suitable format. For example, machine learning engine API 1140 may process XML, and it may also be engineered to handle more compact and efficient data formats, such as Protocol Buffers or Avro, for use in bandwidth-limited scenarios.

In an embodiment, machine learning engine API 1140 is designed to integrate WebSocket technology for applications necessitating real-time data processing and immediate feedback. This integration enables a continuous, bi-directional communication channel for a dynamic and interactive data exchange between the application and machine learning engine 1100.

FIG. 12 illustrates the operation of a machine learning engine in one or more embodiments. In an embodiment, input/output module 1120 receives a dataset intended for training (Operation 1201). This data can originate from diverse sources, like databases or real-time data streams, and in varied formats, such as CSV, JSON, or XML. Input/output module 1120 assesses and validates the data, ensuring its integrity by checking for consistency, data ranges, and types.

In an embodiment, training data is passed to data preprocessing module 1122. Here, the data undergoes a series of transformations to standardize and clean it, making it suitable for training ML models (Operation 1202). This involves normalizing numerical data, encoding categorical variables, and handling missing values through techniques like imputation.

In an embodiment, prepared data from the data preprocessing module 1122 is then fed into model selection module 1124 (Operation 1203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 1126 trains the selected model with the prepared dataset (Operation 1204). It implements learning algorithms to adjust the model's internal parameters, optimizing them to identify patterns and relationships in the training data. Training module 1126 also addresses the challenge of overfitting by implementing techniques, like regularization and early stopping, ensuring the model's generalizability.

In an embodiment, evaluation and tuning module 1128 evaluates the trained model's performance using the validation dataset (Operation 1205). Evaluation and tuning module 1128 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 1120 receives a dataset intended for inference. Input/output module 1120 assesses and validates the data (Operation 1206).

In an embodiment, data preprocessing module 1122 receives the validated dataset intended for inference (Operation 1207). Data preprocessing module 1122 ensures that the data format used in training is replicated for the new inference data, maintaining consistency and accuracy for the model's predictions.

In an embodiment, inference module 1130 processes the new data set intended for inference, using the trained and tuned model (Operation 1208). It applies the model to this data, generating raw probabilistic outputs for predictions. Inference module 1130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In one or more embodiments, a machine learning model is trained to prioritize compute instance templates according to how the cloud service prefers to use compute resources. The model may be trained on a set of prioritized compute instance templates. When a new compute instance template is created and added to the system, the machine learning model may be applied to the new compute instance template to determine a priority of the new compute instance template. The cloud service may, for example, assign the highest priority to ARM-based compute instance templates, followed by burstable VMs, then flex-based x86-based compute instance templates, and then fixed x86-based compute instance templates as the lowest priority.

In one or more embodiments, a machine learning model is trained to rank and/or weight compute instance templates in a filtered list according to the priorities assigned and according to current availability in the region where a compute instance is requested. The model may be trained on a training set of prioritized compute instance templates and information about availability when the compute instance templates were selected to create compute instances. The training set may include information about a cost of operation associated with a compute instance template and/or information about a performance metric associated with a compute instance template. In a scenario where there are few available resources to provide the higher priority compute instances and a large number of resource to provide a lower priority compute instance, the model may be applied to the filtered list and may rank or weight the compute instance templates corresponding to the lower priority compute instance higher than the compute instance templates corresponding to the higher priority compute instances based on the availability information.

### 7. Practical Applications, Advantages, and Improvements

Conventional approaches to provisioning compute instances and clusters of compute instances may restrict the compute instances to static predefined configurations and do not consider what compute resources are available in a region where a customer wishes to operate one or more virtual machines. Cloud computing service providers may also require that the customer specify particular hardware components to use such as a particular processor architecture. When the customer does not have any particular requirements, imposing such a specification may restrict the set of compute resources that can be used to satisfy the customer's request for one or more virtual machines.

The one or more embodiments described herein provide a more flexible and hardware agnostic approach to providing one or more compute instances, based on a customer request, that filter a set of candidate compute instance templates corresponding to available resources. The filters include compute instance templates corresponding to compute instances that are capable of providing the compute resources requested by the customer and exclude the compute instance templates corresponding to compute instances that are not capable of providing the requested compute resources. The customer can request a particular number of nodes without needing to specify any particular actual hardware in the request. The system can fulfill the request with the resources that are available and meet the filtering criteria, allowing the cloud service provider to use more of the cloud computing resources. Additionally, clusters or groups of compute instances can be heterogeneous while still having comparable performance characteristics.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource on the condition that the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset on the condition that the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates what tenants have authorization to access specific applications. For each application, a list of tenant IDs of tenants authorized to access the application is stored. A tenant is permitted access to a particular application on the condition that the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network but not to other tenant overlay networks. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium includes instructions that, when executed by one or more hardware processors, causes performance of any of the operations described herein and/or recited in any of the claims.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, the scope of the present disclosure is not limited to the described series of transactions and steps. Various features and aspects of the above-described embodiments may be used individually or jointly.

Further, while embodiments have been described using a particular combination of hardware and software, one should recognize that other combinations of hardware and software are also within the scope of the present disclosure. Embodiments may be implemented exclusively in hardware, or exclusively in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. Additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if the value were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth entirely herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form such claims issue, including any subsequent correction.

1. One or more non-transitory computer-readable media comprising instructions that, when executed by one or more hardware processors, causes performance of operations comprising:
receiving a request to provision a first compute instance, the first compute instance defined at least by a set of one or more requirements independent of particular hardware specifications, wherein the set of one or more requirements comprises at least one of:
a number of virtual cores, wherein a virtual core comprises an abstraction of a hardware processing unit having defined performance metrics without requiring a particular model or manufacturer;
an amount of virtual memory, wherein virtual memory comprises an abstraction of memory hardware having defined performance metrics without requiring a particular model or manufacturer; and
a virtual input/output (I/O) capacity, wherein the virtual I/O capacity comprises an abstraction of I/O hardware having defined performance metrics without requiring a particular model or manufacturer;
obtaining a set of candidate compute instance templates, wherein a first compute instance template in the set of candidate compute instance templates comprises a first particular hardware specification and wherein a second compute instance template in the set of candidate compute instance templates comprises a second particular hardware specification that is different than the first particular hardware specification;
filtering the set of candidate compute instance templates based at least in part on the set of one or more requirements, to obtain a first filtered list comprising at least the first candidate compute instance template and the second candidate compute instance template; and
provisioning the first compute instance based on a first selected compute instance template from the first filtered list.

2. The one or more computer-readable media of claim 1, the operations further comprising:
operating the first compute instance as part of a cluster of compute instances for an associated virtual machine;
wherein at least one compute instance in the cluster of compute instances was provisioned based on a second selected compute instance template different than the first selected compute instance template.

3. The one or more computer-readable media of claim 1, the operations further comprising:
periodically monitoring the first compute instance at least by comparing one or more components of the first compute instance with a configuration definition associated with the first selected compute instance template; and
responsive to determining that a first compute instance does not comply with the configuration definition: terminating the first compute instance.

4. The one or more computer-readable media of claim 1, the operations further comprising:
obtaining a second set of one or more candidate compute instance templates;
filtering the second set of one or more candidate compute instance templates based at least in part on the set of one or more requirements to obtain a second filtered list;
selecting a second compute instance template from the second filtered list, wherein the second selected compute instance template is different from the first selected compute instance template;
provisioning a second compute instance based on the second selected second compute instance template; and
replacing the first compute instance with the second compute instance.

5. The one or more computer-readable media of claim 1, wherein filtering the candidate compute instance templates comprises:
prior to receiving the request to provision the first compute instance:
performing a first benchmark of the first particular hardware specification associated with the first compute instance template, to obtain a first benchmark result;
performing a second benchmark of the second particular hardware specification associated with the second compute instance template, to obtain a second benchmark result; and
based at least in part on the first benchmark result and the second benchmark result, storing respective mappings of the first compute instance template and the second compute instance template to respective sets of performance metrics;
wherein the respective sets of performance metrics indicate that the first compute instance template and the second compute instance template both satisfy the set of one or more requirements despite being associated with different underlying hardware specifications.

6. The one or more computer-readable media of claim 1, wherein filtering the candidate compute instance templates comprises:
discarding at least one candidate compute instance template from the set of candidate compute instance templates based on a determination that the at least one candidate compute instance template does not satisfy the set of one or more requirements.

7. The one or more computer-readable media of claim 1, wherein the request to provision a compute instance comprises a specified number of nodes, the operations further comprising:
determining a number of virtual cores and an amount of virtual memory needed to support the specified number of nodes;
wherein the set of one or more requirements specifies the number of virtual cores and the amount of virtual memory needed to support the specified number of nodes.

8. The one or more computer-readable media of claim 1, wherein filtering the candidate compute instance templates comprises filtering the candidate compute instance templates based on one or more of:
a version of software that will operate on the compute;
a specified custom image for a virtual machine that will execute on the compute instance;
a cost of operation; and
an availability limit within a tenancy.

9. The one or more computer-readable media of claim 1, the operations further comprising:
training a machine learning model to weight the candidate compute instance templates in the set of candidate compute instance templates according to one or more weighting criteria;
applying the trained machine learning model to the set of candidate compute instance templates in the first filtered list; and
selecting the compute instance template from the first filtered list according to the weight.

10. The one or more computer-readable media of claim 9, wherein the one or more weighting criteria comprises one or more of a cost of operation, hardware availability, or performance.

11. The one or more computer-readable media of claim 1, the operations further comprising:
training a machine learning model to rank the set of candidate compute instance templates in the first filtered list according to one or more criteria; and
responsive to determining that the first filtered list includes a number of candidate compute instance templates that exceeds a specified maximum number, discarding one or more of the lowest ranked candidate compute instance templates from the first filtered list until the number of candidate compute instance templates in the first filtered list is at or below the specified maximum number.

12. A method comprising:
receiving a request to provision a first compute instance, the first compute instance defined at least by a set of one or more requirements independent of particular hardware specifications, wherein the set of one or more requirements comprises at least one of:
a number of virtual cores, wherein a virtual core comprises an abstraction of a hardware processing unit having defined performance metrics without requiring a particular model or manufacturer;
an amount of virtual memory, wherein virtual memory comprises an abstraction of memory hardware having defined performance metrics without requiring a particular model or manufacturer; and
a virtual input/output (I/O) capacity, wherein the virtual I/O capacity comprises an abstraction of I/O hardware having defined performance metrics without requiring a particular model or manufacturer;
obtaining a set of candidate compute instance templates, wherein a first compute instance template in the set of candidate compute instance templates comprises a first particular hardware specification and wherein a second compute instance template in the set of candidate compute instance templates comprises a second particular hardware specification that is different than the first particular hardware specification;
filtering the set of candidate compute instance templates based at least in part on the set of one or more requirements, to obtain a first filtered list comprising at least the first candidate compute instance template and the second candidate compute instance template; and
provisioning the first compute instance based on a first selected compute instance template from the first filtered list;
wherein the method is performed by at least one device including a hardware processor.

13. The method of claim 12, further comprising:
operating the first compute instance as part of a cluster of compute instances for an associated virtual machine;
wherein at least one compute instance in the cluster of compute instances was provisioned based on a second selected compute instance template different than the first selected compute instance template.

14. The method of claim 12, further comprising:
periodically monitoring the first compute instance at least by comparing one or more components of the first compute instance with a configuration definition associated with the first selected compute instance template; and
responsive to determining that a first compute instance does not comply with the configuration definition: terminating the first compute instance.

15. The method of claim 12, further comprising:
obtaining a second set of one or more candidate compute instance templates;
filtering the second set of one or more candidate compute instance templates based at least in part on the set of one or more requirements to obtain a second filtered list;
selecting a second compute instance template from the second filtered list, wherein the second selected compute instance template is different from the first selected compute instance template;
provisioning a second compute instance based on the second selected second compute instance template; and
replacing the first compute instance with the second compute instance.

16. The method of claim 12, further comprising:
prior to receiving the request to provision the first compute instance:
performing a first benchmark of the first particular hardware specification associated with the first compute instance template, to obtain a first benchmark result; and
performing a second benchmark of the second particular hardware specification associated with the second compute instance template, to obtain a second benchmark result;
based at least in part on the first benchmark result and the second benchmark result, storing respective mappings of the first compute instance template and the second compute instance template to respective sets of performance metrics;
wherein the respective sets of performance metrics indicate that the first compute instance template and the second compute instance template both satisfy the set of one or more requirements despite being associated with different underlying hardware specifications.

17. The method of claim 12, wherein filtering the candidate compute instance templates comprises:
discarding at least one candidate compute instance template from the set of candidate compute instance templates based on a determination that the at least one candidate compute instance template does not satisfy the set of one or more requirements.

18. The method of claim 12, wherein the request to provision a compute instance comprises a specified number of nodes, further comprising:
determining a number of virtual cores and an amount of virtual memory needed to support the specified number of nodes;
wherein the set of one or more requirements specifies the number of virtual cores and the amount of virtual memory needed to support the specified number of nodes.

19. The method of claim 12, wherein filtering the candidate compute instance templates comprises filtering the candidate compute instance templates based on one or more of:
a version of software that will operate on the compute;
a specified custom image for a virtual machine that will execute on the compute instance;
a cost of operation; and
an availability limit within a tenancy.

20. A system comprising:
one or more processors; and
memory storing instructions that, when executed by the one or more processors, cause the system to perform:
receiving a request to provision a first compute instance, the first compute instance defined at least by a set of one or more requirements independent of particular hardware specifications, wherein the set of one or more requirements comprises at least one of:
a number of virtual cores, wherein a virtual core comprises an abstraction of a hardware processing unit having defined performance metrics without requiring a particular model or manufacturer;
an amount of virtual memory, wherein virtual memory comprises an abstraction of memory hardware having defined performance metrics without requiring a particular model or manufacturer; and
a virtual input/output (I/O) capacity, wherein the virtual I/O capacity comprises an abstraction of I/O hardware having defined performance metrics without requiring a particular model or manufacturer;
obtaining a set of candidate compute instance templates, wherein a first compute instance template in the set of candidate compute instance templates comprises a first particular hardware specification and wherein a second compute instance template in the set of candidate compute instance templates comprises a second particular hardware specification that is different than the first particular hardware specification;
filtering the set of candidate compute instance templates based at least in part on the set of one or more requirements, to obtain a first filtered list comprising at least the first candidate compute instance template and the second candidate compute instance template; and
provisioning the first compute instance based on a first selected compute instance template from the first filtered list.
